(19) United States
(12) Patent Application Publication
(10) Pub. No.: US 2013/0101431 A1
(43) Pub. Date: Apr. 25, 2013

(54) ROTOR, A STEAM TURBINE AND A METHOD FOR PRODUCING A ROTOR

(71) Applicants: Thomas Joseph FARINEAU, Schenectady, NY (US); Manuel Julio Gomez FERNANDEZ, Ribadavia (Ourense) (ES)

(72) Inventors: Thomas Joseph FARINEAU, Schenectady, NY (US); Manuel Julio Gomez FERNANDEZ, Ribadavia (Ourense) (ES)

(73) Assignee: GENERAL ELECTRIC COMPANY, Schenectady, NY (US)

(21) Appl. No.: 13/278,537

(22) Filed: Oct. 21, 2011

(51) Int. Cl. F01D 5/14; B23P 11/00

(52) U.S. Cl. 416/241 R; 29/889

(57) ABSTRACT

A rotor having a first low temperature material section, a second low temperature material section attached to a first end of the first low temperature material section and a third low temperature material section joined to a first end of the second low temperature material section. The first, second and third temperature material sections are exposed to steam at a pressure less than about 180 bar. A steam turbine and a method for producing a rotor are also disclosed.

### FIELD OF THE INVENTION

The present invention is generally directed to steam turbines, and more specifically directed to a steam turbine having a welded rotor shaft.

### BACKGROUND OF THE INVENTION

A typical steam turbine plant may be equipped with a high pressure steam turbine, an intermediate pressure steam turbine and a low pressure steam turbine. Each steam turbine is formed of materials appropriate to withstand operating conditions, pressure, temperature, flow rate, etc., for that particular turbine.

Recently, steam turbine plant designs directed toward a larger capacity and a higher efficiency have been designed that include steam turbines that operate over a range of pressures and temperatures. The designs have included high-low pressure integrated, high- intermediate—low pressure integrated, and intermediate-low pressure integrated steam turbine rotors integrated into one piece and using the same metal material for each steam turbine. Often, a single piece component is more expensive or not available in a timely manner.

A steam turbine conventionally includes a rotor and a casing jacket. The rotor includes a rotatably mounted turbine shaft that includes blades. When heated and pressurized steam flows through the flow space between the casing jacket and the rotor, the turbine shaft is set in rotation as energy is transferred from the steam to the rotor. The rotor, and in particular the rotor shaft, often forms of the bulk of the metal of the turbine. Thus, the metal that forms the rotor significantly contributes to the cost of the turbine. If the rotor is formed of a single forging, the cost is even further increased.

Accordingly, it would be desirable to provide a combined high pressure/intermediate pressure steam turbine rotor formed of multiple lower cost forgings that are welded together.

### SUMMARY OF THE INVENTION

According to an exemplary embodiment of the present disclosure, a rotor is disclosed. The rotor includes a first low temperature material section, a second low temperature material section attached to a first end of the first low temperature material section and a third low temperature material section joined to a first end of the second low temperature material section. The first, second and third temperature material sections are exposed to steam at a pressure less than about 180 bar.

According to another exemplary embodiment of the present disclosure, a steam turbine is disclosed that includes a rotor. The rotor includes a first low temperature material section, a second low temperature material section attached to a first end of the first low temperature material section, and a third low temperature material section joined to a first end of the second low temperature material section. The first, second and third temperature material sections are exposed to steam at a pressure less than about 180 bar.

According to another exemplary embodiment of the present disclosure, a method of manufacturing a rotor is disclosed. The method includes providing a first low temperature material section, joining the first low temperature material section to an end of a second low temperature material section, and joining a second low temperature material section to an end of a third low temperature material section. The first, second and third low temperature material sections are formed of a forged alloy steel.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a sectional view of a steam turbine according to the present disclosure.

Wherever possible, the same reference numbers will be used throughout the drawings to represent the same parts.

### DETAILED DESCRIPTION OF THE INVENTION

The present disclosure now will be described more fully hereinafter with reference to the accompanying drawings, in which an exemplary embodiment of the disclosure is shown. This disclosure may, however, be embodied in many different forms and should not be construed as limited to the embodiments set forth herein.

Provided is a combined high pressure/intermediate pressure steam turbine rotor formed of multiple lower cost forgings that are welded together. In embodiments of the present disclosure, the system configuration provides a lower cost steam turbine rotor. Another advantage of an embodiment of the present disclosure includes reduced manufacturing time as the lead time for procuring a multi-component rotor is less than that of a rotor forged from a single-piece forging. Embodiments of the present disclosure allow the fabrication of the high pressure/intermediate pressure rotor from a series of smaller forgings made from the same material that are either a) less expensive on a per pound basis than a single forging or b) offer a time savings in terms of procurement cycle vs. a single larger one-piece forging. Such arrangements provide less expensive manufacturing.

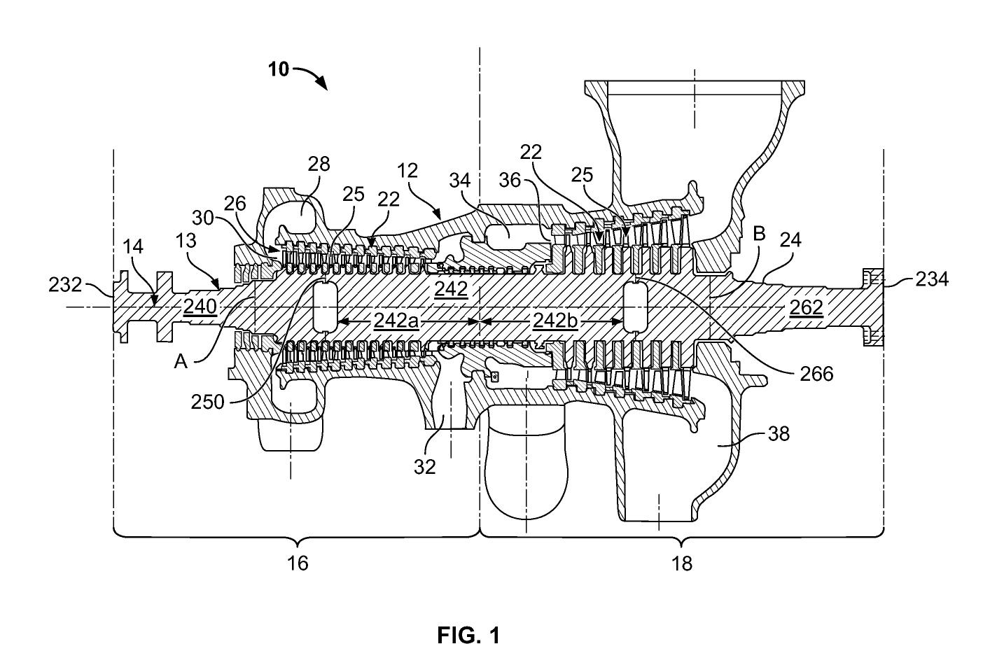

FIG. 1 illustrates a sectional diagram of a steam turbine 10 according to an embodiment of the disclosure. The steam turbine 10 includes a single wall casing 12 in which a turbine rotor 13 is mounted rotatably about an axis of rotation 14. The steam turbine 10 includes a first section 16 and a second section 18. The steam turbine 10 operates at sub-critical operating conditions. In one embodiment, the steam turbine 10 receives steam at a pressure below about 180 bar. In another embodiment, the steam turbine 10 receives steam at a pressure between about 110 bar to about 180 bar. In another embodiment, the steam turbine 10 receives steam at a pressure between about 120 bar to about 175 bar. Additionally, the steam turbine 10 receives steam at a temperature between about 525° C. and about 600° C. In another embodiment, the steam turbine 10 receives steam at a temperature between about 535° C. and about 570° C. In another embodiment, the steam turbine 10 receives steam at a temperature between about 538° C. and about 565° C.

The casing 12 is a single, integrated casing. In another embodiment, the casing 12 may be a double-wall casing. The casing 12 includes a plurality of guide vanes 22. The rotor 13 includes a shaft 24 and a plurality of blades 25 fixed to the shaft 24. The shaft 24 is rotatably supported in the casing 12 by bearing (not shown). In another embodiment, various bearing support configurations may be used.

A main steam flow path 26 is defined as the path for steam flow between the casing 12 and the rotor 13. The main steam flow path 26 includes a first main steam flow path section 30 located in the first turbine section 16 or HP turbine section and a second main steam flow path section 36 located in the second turbine section 18 or IP turbine section. As used herein, the term “main steam flow path” means the primary flow path of steam that produces power.

Steam is provided to a first inlet region 32 of the main steam flow path 26. The steam flows through the first main steam flow path section 30 of the main steam flow path 26 between vanes 22 and blades 25, during which the steam expands and cools. Thermal energy of the steam is converted into mechanical, rotational energy as the steam rotates the rotor 13 about the axis 14. After flowing through the first main steam flow path section 30, the steam flows out of a first steam outlet region 28 into a superheater (not shown), where the steam is heated to a higher temperature. The steam is introduced via lines (not shown) to a second steam inlet region 34. The steam flows through the second main steam flow path section 36 of the main steam flow path 26 between vanes 22 and blades 25, during which the steam expands and cools. Additional thermal energy of the steam is converted into mechanical, rotational energy as the steam rotates the rotor 13 about the axis 14. After flowing through the second main steam flow path section 36, the steam flows out of a second steam outlet region 38 out of the steam turbine 10. The steam may be used in other operations, not illustrated in any more detail.

Referring again to FIG. 1, the shaft 24 includes a first low temperature material (LTM) section 240, a second LTM section 242, and a third LTM section 262. The first LTM section and a first portion 242a of the second LTM section 242 are disposed or located in the first section 16 of the steam turbine 10. A second portion 242b of the second LTM section 242 and the third LTM section 262 are disposed or located in the second section 18 of the steam turbine 10.

The first LTM section 240 may be joined to another component (not shown) at a first end 232 by a bolted joint, a weld, or other joining technique. In an embodiment, the first LTM section may be bolted to a generator at the first end 232. The third section 262 may be joined to another component (not shown) at a second end 234 by a bolted joint, a weld, or other joining technique. In an embodiment, the third section 262 may be joined to a low pressure section of a power generator (not shown). In an embodiment, the low pressure section of a power generator may include a low pressure turbine.

The first section 16 receives steam via the first inlet region 32 at sub-critical operating conditions. In one embodiment, the first section 16 receives steam at a pressure below about 180 bar. In another embodiment, the first section 16 receives steam at a pressure between about 110 bar to about 180 bar. In another embodiment, the first section 16 receives steam at a pressure between about 120 bar to about 175 bar. Additionally, the first section 16 receives steam at a temperature between about 525° C. and about 600° C. In another embodiment, the first section 16 receives steam at a temperature between about 535° C. and about 570° C. In another embodiment, the first section 16 receives steam at a temperature between about 538° C. and about 565° C.

The second section 18 receives steam at a pressure below about 70 bar. In another embodiment, the second section 18 may receive steam at a pressure of between about 20 bar to 70 bar. In yet another embodiment, the second section 18 may receive steam at a pressure of between about 20 bar to about 40 bar. Additionally, the second section 18 receives steam at a temperature between about 525° C. and about 600° C. In another embodiment, the second section 18 receives steam at a temperature between about 535° C. and about 570° C. In another embodiment, the second section 18 receives steam at a temperature between about 538° C. and about 565° C.

The first LTM section 240 is joined to the second LTM section 242 by a first weld 250. In this exemplary embodiment, the first weld 250 is located along the first main steam flow path section 30. In another embodiment, alternatively, the first weld 250 may be located outside or not in contact with the first main steam flow path section 30. In an embodiment, the first weld 250 may be located at position “A” outside and not in contact with the first main steam flow path section 30, but in contact with seal steam leakage.

The second and third LTM sections 242, 262 are joined by a second weld 266. The second weld 266 is located along the second main steam flow path section 36. In an embodiment, the second weld 266 may be located along the second main steam flow path section 36 where the steam temperature is less than 455° C. In another embodiment, the second weld 266 may be located outside or not in contact with the second main steam flow path section 36. For example, alternatively, the second weld 266 may be located at position “B” located outside and not in contact with the second main steam flow path section 36.

In one embodiment, the first, second and third LTM sections 240, 242, 262 are formed of a single, unitary section or block of low temperature material. In another embodiment, the first, second and third LTM sections 240, 242, 262 may be formed of two or more LTM sections or blocks of low temperature material that has been joined together. In still another embodiment, the first, second and third LTM sections 240, 242, 262 may each be formed of one or more LTM sections or blocks of low temperature material welded together.

The low temperature material (LTM) may be a forged alloy steel. In an embodiment, the forged alloy steel may be a low alloy steel. In an embodiment, the low temperature material may be a CrMoVNi alloy steel. In an embodiment, Cr may be included in an amount between about 0.5 wt. % and about 2.2 wt. %. In another embodiment, Cr may be included in an amount between about 0.5 wt. % and about 2.0 wt. %. In another embodiment, Cr may be included in an amount between about 0.9 wt. % and about 1.3 wt. %. In an embodiment, Mo may be included in an amount between about 0.5 wt. % and about 2.0 wt. %. In another embodiment, Mo may be included in an amount between about 1.0 wt. % and about 1.5 wt. %. In an embodiment, V may be included in an amount between about 0.1 wt. % and about 0.5 wt. %. In another embodiment, V may be included in an amount of between about 0.2 wt. % and about 0.3 wt. %. In an embodiment, Ni may be included in an amount between about 0.2 wt. % to about 1.0 wt. %. In another embodiment, Ni may be included in an amount between about 0.3 wt. % and about 0.6 wt. %. In an embodiment, Mn may be included in an amount between about 0.5 wt. % to about 1.0 wt. %. In another embodiment, Mn may be included in an amount between about 0.65 wt. % and about 0.85 wt. %. In an embodiment, C may be included in an amount between about 0.2 wt. % and about 0.4 wt. %. In another embodiment, C may be included in an amount between about 0.25 wt. % and about 0.33 wt. %. The balance of the alloy steel is essentially Fe and incidental impurities.

In an embodiment, the first, second and third LTM sections 240, 242, 262 may have the same composition. In another embodiment, the first, second and third LTM sections 240, 242, 262 may have different compositions.

As shown in FIG. 1, the first LTM section 242 at least partially defines the first main steam flow path section 30. The second LTM section 262 further at least partially defines the first main steam flow path section 30. In another embodiment, the weld 250 may be moved, for example to position “A”, so that the first LTM section 240 does not at least partially define the first main steam flow path section 30 or, in other words, the first LTM section 240 is outside of the first main steam flow path section 30 and does not contact main steam flow path 26.

Similarly, the third LTM section 262 at least partially defines second main steam flow path section 36. The second LTM section 242 further at least partially defines the second main steam flow path section 36. In another embodiment, the weld 266 may be moved, for example, to position “B”, so that the third LTM section 262 does not at least partially define the second main steam flow path section 36 or, in other words, the third LTM section 262 is outside of the second main steam flow path section 36 and does not contact main steam flow path 26.

While only certain features and embodiments of the invention have been shown and described, many modifications and changes may occur to those skilled in the art (for example, variations in sizes, dimensions, structures, shapes and proportions of the various elements, values of parameters (for example, temperatures, pressures, etc.), mounting arrangements, use of materials, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A rotor, comprising:
a first low temperature material section;
a second low temperature material section attached to a first end of the first low temperature material section;
a third low temperature material section joined to a first end of the second low temperature material section;
wherein the first, second and third temperature material sections are exposed to steam at a pressure less than about 180 bar.

2. The rotor of claim 1, wherein the first, second and third low temperature material sections are formed of a forged alloy steel.

3. The rotor of claim 2, wherein the forged alloy steel comprises:
about 0.5 wt. % to about 2.2 wt. % Cr;
about 0.5 wt. % to about 2.0 wt. % Mo;
about 0.1 wt. % to about 0.5 wt. % V;
about 0.2 wt. % to about 1.0 wt. % Ni; and
about 0.5 wt. % to about 1.0 wt. % Mn.

4. The rotor of claim 2, wherein the forged alloy steel comprises:
about 0.5 wt. % to about 2.0 wt. % Cr;
about 0.5 wt. % to about 2.0 wt. % Mo;
about 0.1 wt. % to about 0.5 wt. % V;
about 0.2 wt. % to about 1.0 wt. % Ni; and
about 0.65 wt. % to about 0.85 wt. % Mn.

5. The rotor of claim 2, wherein the forged alloy steel comprises:
about 0.9 wt. % to about 1.3 wt. % Cr;
about 0.5 wt. % to about 2.0 wt. % Mo;
about 0.1 wt. % to about 0.5 wt. % V;
about 0.2 wt. % to about 1.0 wt. % Ni;
about 0.65 wt. % to about 0.85 wt. % Mn;
about 0.25 wt. % to about 0.33 wt. % C; and balance Fe and incidental impurities.

6. The rotor of claim 1, wherein the first, second and third low temperature material sections have the same composition.

7. A steam turbine, comprising:
a rotor, comprising:
a first low temperature material section;
a second low temperature material section attached to a first end of the first low temperature material section;
a third low temperature material section joined to a first end of the second low temperature material section;
wherein the first, second and third temperature material sections are exposed to steam at a pressure less than about 180 bar.

8. The steam turbine of claim 7, further comprising:
a single wall casing surrounding the rotor.

9. The steam turbine of claim 8, wherein the first low temperature material section at least partially defines the main steam flow path between the rotor and the single wall casing.

10. The steam turbine of claim 7, wherein the first, second and third low temperature material sections are formed of a forged alloy steel.

11. The steam turbine of claim 10, wherein the forged alloy steel comprises:
about 0.5 wt. % to about 2.2 wt. % Cr;
about 0.5 wt. % to about 2.0 wt. % Mo;
about 0.1 wt. % to about 0.5 wt. % V; and
about 0.2 wt. % to about 1.0 wt. % Ni.

12. The steam turbine of claim 10, wherein the forged alloy steel comprises:
about 0.5 wt. % to about 2.0 wt. % Cr;
about 0.5 wt. % to about 2.0 wt. % Mo;
about 0.1 wt. % to about 0.5 wt. % V; and
about 0.2 wt. % to about 1.0 wt. % Ni.

13. The steam turbine of claim 10, wherein the forged alloy steel comprises:
about 0.9 wt. % to about 1.3 wt. % Cr;
about 0.5 wt. % to about 2.0 wt. % Mo;
about 0.1 wt. % to about 0.5 wt. % V;
about 0.2 wt. % to about 1.0 wt. % Ni;
about 0.65 wt. % to about 0.85 wt. % Mn;
about 0.25 wt. % to about 0.33 wt. % C; and
balance Fe and incidental impurities.

14. The steam turbine of claim 7, wherein the first, second and third low temperature material sections have the same composition.

15. A method of manufacturing a rotor, comprising:
providing a first low temperature material section; and
joining the first low temperature material section to an end of a second low temperature material section; and
joining a second low temperature material section to an end of a third low temperature material section;
wherein the first, second and third low temperature material sections are formed of a forged alloy steel.

16. The method of claim 15, wherein the first, second and third low temperature material sections are formed of a forged alloy steel.

17. The method of claim 16, wherein the forged alloy steel comprises:
about 0.5 wt. % to about 2.0 wt. % Cr;
about 0.5 wt. % to about 2.0 wt. % Mo;
about 0.1 wt. % to about 0.5 wt. % V; and
about 0.2 wt. % to about 1.0 wt. % Ni.

18. The method of claim 16, wherein the forged alloy steel comprises:
about 0.9 wt. % to about 1.3 wt. % Cr;
about 0.5 wt. % to about 2.0 wt. % Mo;
about 0.1 wt. % to about 0.5 wt. % V;
about 0.2 wt. % to about 1.0 wt. % Ni;
about 0.65 wt. % to about 0.85 wt. % Mn;
about 0.25 wt. % to about 0.33 wt. % C; and
balance Fe and incidental impurities.

19. The method of claim 15, wherein the first, second and third low temperature material sections have the same composition.

20. The method of claim 15, wherein the first, second and third low temperature material sections are joined by welding.
